(19) United States
(12) Patent Application Publication
(10) Pub. No.: US 2011/0081014 A1
(43) Pub. Date: Apr. 7, 2011

(54) Subscriber Line Interface Circuitry with POTS Detection

(76) Inventor: Yan Zhou, Austin, TX (US)

(21) Appl. No.: 12/571,436

(22) Filed: Oct. 1, 2009

(51) Int. Cl. H04M 9/00

(52) U.S. Cl. 379/413

(57) ABSTRACT

A subscriber line interface circuit (SLIC) apparatus includes a first memory for storing a first battery feed characteristic profile and a second memory for storing a second battery feed characteristic profile. The SLIC includes selection circuitry for selecting one of the first and second battery feed characteristic profiles from the corresponding first and second memories as a selected battery feed characteristic profile in accordance with a selection bit. The subscriber line interface circuitry controls a subscriber line battery feed in accordance with the selected battery feed characteristic profile.

### FIELD OF THE INVENTION

This invention relates to the field of telecommunications. In particular, this invention is drawn to subscriber line interface circuitry.

### BACKGROUND

The plain old telephone system (POTS) was initially architected to carry voice data in analog form from one subscriber to another via configurable switches. Although the telephone network evolved to using a digital transport network (i.e., the Public Switched Telephone Network (PSTN)), communication on the subscriber line connecting subscribers to the central office that serves as the entry point to the PSTN is analog. The “last mile” between the subscriber and the central office was architected for analog communications in the voiceband frequency range.

Although modems were developed to enable communicating digital data using the same analog channel used to carry analog voice data, the digital data rates between the subscriber and central office were relatively low due to the constraints of operating exclusively within the voiceband region of the spectrum. Numerous communication protocol standards have since developed to enable using the POTS infrastructure for communicating digital data at higher data rates by utilizing communication bandwidth beyond the voiceband. For example, digital subscriber line (xDSL) services utilize communication bandwidth beyond and exclusive to the voiceband. As a result, xDSL services may co-exist with POTS communications.

POTS equipment at the customer premises requires POTS functions for operation. Traditionally, the POTS functions are provided by a subscriber line interface circuit (SLIC) at the central office. However, as the digital data rates increased and the cost of subscriber lines provisioned for POTS became more expensive relative to the cost of using packet-based services, some customers began utilizing the xDSL services for carrying voiceband communications as “voice over Internet Protocol” (VOIP). A local SLIC provides a POTS front end for customer premises equipment such as telephones and facsimiles. Instead of connecting to the PSTN, the backend of the SLIC is connected to the xDSL modem for transport as packetized voice data. The subscriber line may thus carry voiceband data either as an analog “POTS” type signal in a circuit-switched communication or as a digital signal in a packet-switched communication.

In some cases, customers have chosen to forgo requesting traditional telephone service in favor of VOIP. In such cases, the customer requires only xDSL provisioning for the subscriber line. In the absence of POTS services provided by the telephone company, the customer may utilize all premises POTS equipment by “injecting” POTS services into a wall plug or other interface for the premises POTS wiring using a local, customer premises SLIC.

One advantage of this approach is that the customer is able to re-deploy all existing POTS equipment on a packet-switched network and often at a considerably less expense than if the POTS services are provided by the local telephone company. However, in the event that the subscriber line is already provisioned or subsequently becomes provisioned for POTS services from the central office SLIC, the ensuing conflict between the central office SLIC and the local SLIC may cause damage to the SLICs or POTS equipment.

### SUMMARY

A subscriber line interface circuit (SLIC) apparatus includes a first memory for storing a first battery feed characteristic profile and a second memory for storing a second battery feed characteristic profile. The SLIC includes selection circuitry for selecting one of the first and second battery feed characteristic profiles from the corresponding first and second memories as a selected battery feed characteristic profile in accordance with a selection bit. The subscriber line interface circuitry controls a subscriber line battery feed in accordance with the selected battery feed characteristic profile.

A method of controlling a subscriber line interface circuit includes storing a first battery feed characteristic profile in a first memory of a subscriber line interface circuit. A second battery feed characteristic profile is stored in a second memory of the subscriber line interface circuit. One of the first and second memories is selected to select one of the first and second battery feed characteristic profiles as a selected characteristic profile in accordance with the value of a selected bit. The subscriber line battery feed is controlled in accordance with the selected characteristic profile.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a plain old telephone system (POTS) communication architecture.

FIG. 2 illustrates one embodiment of a communication spectrum allocation for a subscriber line.

FIG. 3 illustrates one embodiment of a POTS injection apparatus.

FIG. 4 illustrates one embodiment of a method of controlling a customer premises SLIC.

FIG. 5 illustrates one embodiment of a method of selectively coupling POTS equipment for circuit-switched or packet-switched communications on a subscriber line.

FIG. 6 illustrates one embodiment of determining the presence of POTS on a subscriber line.

FIG. 7 illustrates embodiments of battery feed characteristic curves for a subscriber line exhibiting resistance-only characteristics.

FIG. 8 illustrates embodiments of battery feed characteristic curves for a subscriber line coupled to POTS equipment.

FIG. 9 illustrates one embodiment of a SLIC.

FIG. 10 illustrates a block diagram of an SLIC including a signal processor and a linefeed driver.

FIG. 11 illustrates one embodiment of a method of selecting battery feed characteristic profiles.

### DETAILED DESCRIPTION

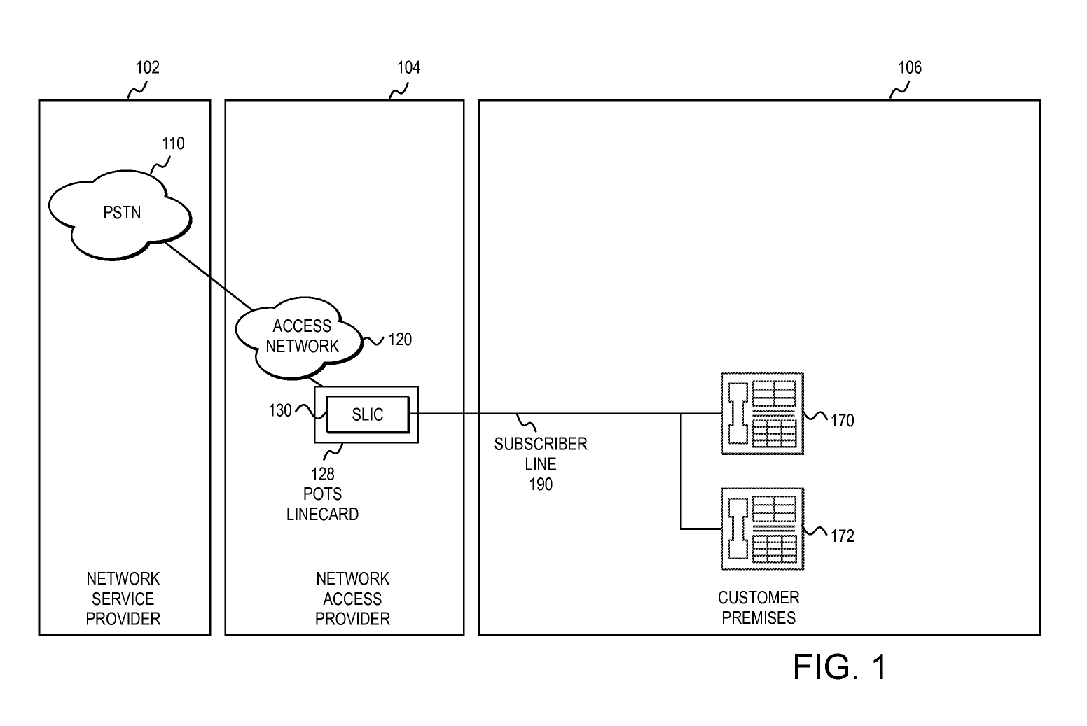

FIG. 1 illustrates one embodiment of a prior art communications network model supporting voiceband communications associated with plain old telephone services (POTS) telephone system. The network model is divided into three physical domains: network service provider(s) 102, network access providers 104, and customer premises 106.

The network service providers (NSP) may have networks that span large geographic areas. Typically, however, the customer premises (CP) must be located within a specified distance of the network access provider (NAP) as a result of electrical specifications on the subscriber line 190. Thus network access providers typically have a number of central offices (CO) that support customers within a specified radius. Local exchange carriers (LEC) and competitive local exchange carriers (CLEC) are examples of network access providers.

In one embodiment, the network access provider is a telephone company. Subscriber equipment (i.e., customer premises equipment such as telephones 170, 172) is connected to a central office (CO) of the network access provider 104 via a subscriber line 190. For POTS systems, the subscriber line includes a tip line and a ring line that are typically implemented as an unshielded twisted copper wire pair.

The central office has numerous POTS linecards 128 for supporting multiple subscriber lines. Each linecard has at least one subscriber line interface circuit (SLIC) 130 that serves as an interface between a digital switching access network 120 of a local telephone company central office and the subscriber equipment 170, 172. In some embodiments, each linecard has a plurality of SLICs. The access network provides the SLIC and associated subscriber with access to the PSTN 110 for bi-directional communication with other subscribers similarly coupled to the PSTN.

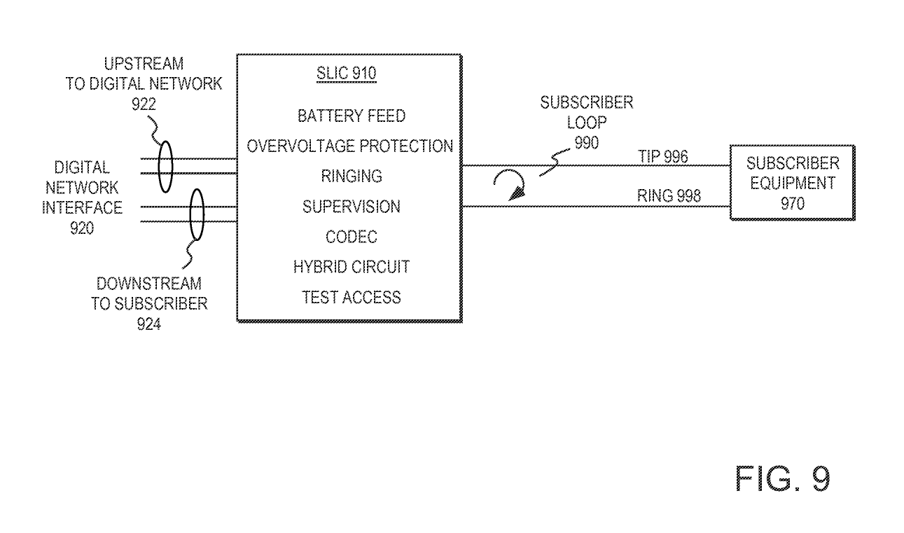

FIG. 9 illustrates one embodiment of a SLIC 910 coupled to subscriber equipment 970 by a subscriber line comprised of tip line 996 and ring line 998. The tip line 996, subscriber equipment 970, and ring line 998 form a subscriber loop 990. The POTS standards establish the electrical specifications and communication protocols for voiceband communications carried by the subscriber line.

The SLIC receives downstream digital voiceband data from a digital network 920 (e.g., the PSTN) on a downstream data path 924 for conversion and communication to the subscriber equipment 970. The SLIC receives upstream analog voiceband data from subscriber equipment 970 for conversion and communication to the digital network 920 on upstream data path 922.

The SLIC is expected to perform a number of functions often collectively referred to as the BORSCHT requirements. BORSCHT is an acronym for “battery feed,” “overvoltage protection,” “ring,” “supervision,” “codec,” “hybrid,” and “test” (e.g., loop diagnostics). The term “battery feed” may be used interchangeably with “linefeed”.

Referring to FIG. 1, the SLIC provides power to the subscriber equipment 170, 172 using the battery feed function. The overvoltage protection function serves to protect the central office circuitry against voltage transients that may occur on the subscriber line 190. The ringing function enables the SLIC to signal the subscriber equipment 170, 172 (e.g., ringing a telephone).

The supervision function enables the SLIC to detect subscriber equipment service requests such as when the caller goes “off-hook”. The supervision function is also used to supervise calls in progress and to detect dialing input signals.

The hybrid function provides a conversion from two-wire signaling to four-wire signaling. The transmit path (downstream to subscriber) and receive path (upstream from subscriber) share the same physical lines of the subscriber loop. Given that the upstream signal from the subscriber and the downstream signal from the SLIC share the same subscriber line for communication, the hybrid function typically performs some form of cancellation to remove the downstream signal from the sensed subscriber line in order to distinguish the upstream signal from other signals on the subscriber line.

The SLIC includes a codec to convert the upstream analog voiceband data signal into serial digital codes suitable for transmission by the digital switching network 110. In one embodiment, pulse code modulation is used to encode the voiceband data. The codec also converts the digital downstream voiceband data from serial digital codes to analog signals suitable for downstream transmission on the subscriber line to the subscriber equipment. The SLIC also typically provides a means to test for faults that may exist in the subscriber loop or within the SLIC itself.

Historically, the network access providers served to connect customers or subscribers to the PSTN for voiceband communications (communications having an analog bandwidth of approximately 4 kHz or less). Although the PSTN is digital in nature, the connection (subscriber line 190) between the customer premises 106 and the network access provider 104 is analog.

The subscriber line may be provisioned for additional services by using communication bandwidth beyond the voiceband. Thus, for example, digital subscriber line services may simultaneously co-exist with voiceband communications by using communication bandwidth other than the voiceband. The choice of frequency ranges and line codes for these additional services is the subject of various standards. The International Telecommunication Union (ITU), for example, has set forth a series of recommendations for subscriber line data transmission. These recommendations are directed towards communications using the voiceband portion of the communications spectrum (“V.x” recommendations) as well as communications utilizing frequency spectrum other than the voiceband portion (e.g., “xDSL” recommendations). Various examples of line code standards include quadrature amplitude and phase modulation, discrete multi-tone modulation, carrierless amplitude phase modulation, and two binary one quaternary (2B1Q).

Asymmetric digital subscriber line (ADSL) communications represent one variant of xDSL communications. Exemplary ADSL specifications are set forth in “Rec. G.992.1 (06/99)—Asymmetric digital subscriber line (ADSL) transceivers” (also referred to as full rate ADSL), and “Rec. G.992.2 (06/99)—Splitterless asymmetric digital subscriber line (ADSL) transceivers” (also referred to as G.LITE).

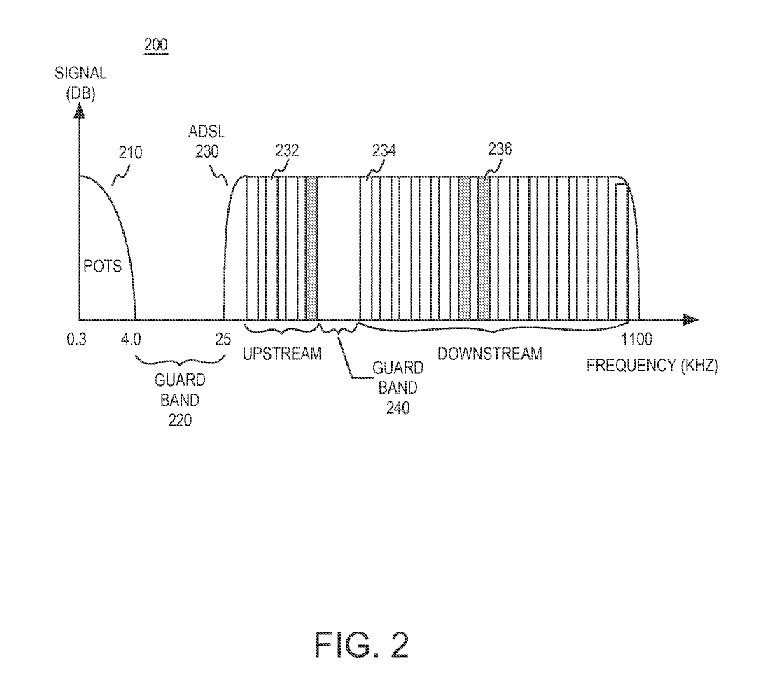

FIG. 2 illustrates one embodiment of communication spectrum allocation for a subscriber line. Chart 200 compares the portions of the analog channel for voiceband applications (POTS 210) as well as digital services (e.g., ADSL 230). POTS communications typically use the voiceband range of 300-4000 Hz. One xDSL variant uses frequencies beyond the voiceband in the range of approximately 25-1100 kHz as indicated. A guard band 220 separates the POTS and ADSL ranges.

There are multiple line coding variations for xDSL. Carrierless Amplitude Phase (CAP) modulation and Discrete Multi-Tone (DMT) modulation both use the fundamental techniques of quadrature amplitude modulation (QAM). CAP is a single carrier protocol where the carrier is suppressed before transmission and reconstructed at the receiving end. DMT is a multicarrier protocol. FIG. 2 illustrates DMT line coding.

DMT modulation has been established as a standard line code for ADSL communication. The available ADSL bandwidth is divided into 256 sub-channels. Each sub-channel 234 is associated with a carrier. The carriers (also referred to as tones) are spaced 4.3125 KHz apart. Each sub-channel is modulated using quadrature amplitude modulation (QAM) and can carry 0-15 bits/Hz. The actual number of bits is allocated depending upon line conditions. Thus individual sub-channels may be carrying different numbers of bits/Hz. Some sub-channels 236 might not be used at all.

ADSL uses some sub-channels 234 for downstream communication and other sub-channels 232 for upstream communication. The upstream and downstream sub-channels may be separated by another guard band 240. ADSL is named for the asymmetry in bandwidth allocated to upstream compared to the bandwidth allocated to downstream communication.

During initialization the signal-to-noise ratio of each DMT sub-channel is measured to determine an appropriate data rate assignment. Generally, greater data rates (i.e., more bits/Hz) are assigned to the lower sub-channels because signals are attenuated more at higher frequencies. DMT implementations may also incorporate rate adaption to monitor the line conditions and dynamically change the data rate for sub-channels.

xDSL can be provisioned using the same subscriber line as that used for standard POTS communications thus leveraging existing infrastructure. The availability of xDSL technology permits delivery of additional services to the subscriber.

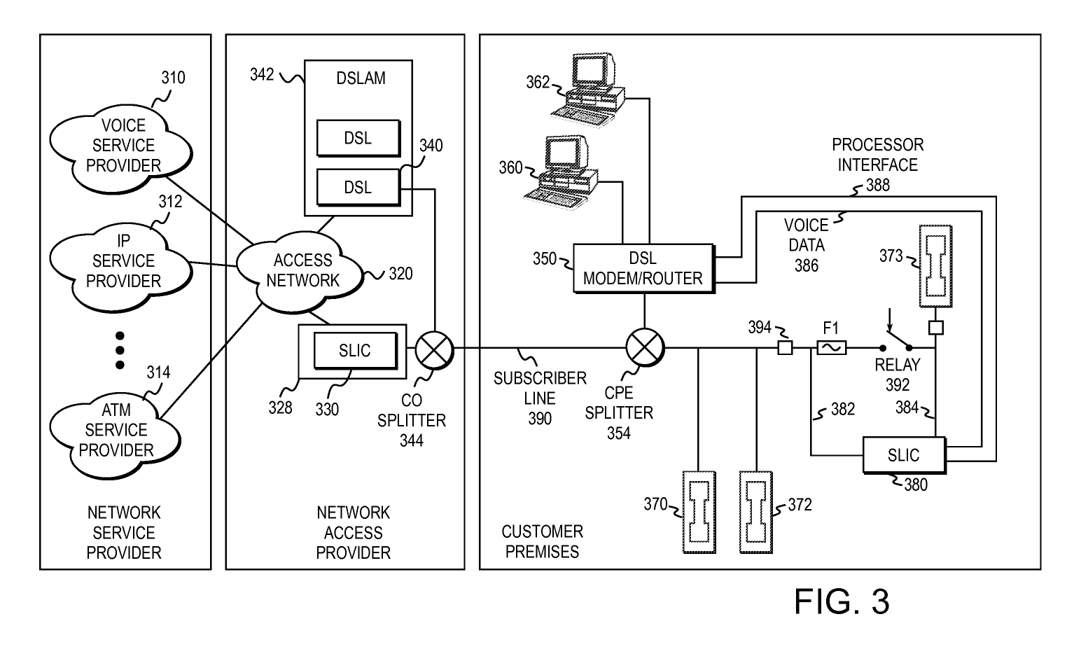

FIG. 3 illustrates an embodiment of a communications network model supporting voice and digital services (e.g., xDSL) on a common subscriber line 390. Various digital services may utilize different encoding algorithms (e.g., two binary one quaternary (2B1Q)). The POTS subscriber equipment such as telephones 370, 372 are connected to a POTS SLIC 330 residing on a POTS linecard 328 via subscriber line 390. The NAP access network 320 couples the POTS linecard to a voice service provider network 310 such as the PSTN.

A digital subscriber line access multiplexer (DSLAM) 342 has a plurality of DSL linecards 340. The access network 320 enables communication with digital network service providers such as Internet protocol (IP) service providers 312 and asynchronous transfer mode (ATM) service providers 314. A DSLAM linecard provides a connection from one of the digital networks via access network 320 to the subscriber line 390 through the use of a central office splitter 344.

The splitter 344 serves to route the appropriate portion of the analog channel of the subscriber line 390 to one of the DSL linecard 340 and the POTS linecard 328. In particular, the splitter filters out the digital portion of the subscriber line communications for the POTS linecard 328. The splitter filters out the voiceband communications for the DSL linecard 340. The splitter also protects the DSL linecard from the large transients and control signals associated with the POTS communications on the subscriber line.

The CO splitter thus effectively splits upstream communications from the subscriber equipment into at least two spectral ranges: voiceband and non-voiceband. The upstream voiceband range is provided to the POTS linecard and the upstream non-voiceband range is provided to the DSL linecard. The splitter couples the distinctly originating downstream voiceband and downstream non-voiceband communications to a common physical subscriber line 390.

A customer premises equipment splitter 354 may also be required at the customer premises for the POTS subscriber equipment 370, 372. The CPE splitter 354 passes only the voiceband portion of the subscriber line communications to the POTS subscriber equipment.

In one embodiment, the CPE splitter provides the DSL communications to a DSL modem 350 that serves as a communications interface for digital subscriber equipment such as computers 360, 362. In one embodiment, the DSL modem includes router functionality.

The DSL service overlays the existing POTS service on the same subscriber line. Some xDSL variants permit the elimination of the CPE splitter with the tradeoff of lower digital communication rates.

A local SLIC 380 is available to provide POTS injection. The local SLIC provides POTS services to the POTS equipment 370, 372 in the event that the subscriber line 390 is not provisioned for POTS services at the central office (i.e., network access provider). In such a case, the central office SLIC 330 is not present or is effectively disabled such that it does not provide POTS services on subscriber line 390. Although the local SLIC 380 is indicated as separate from the DSL modem/router 350, they may be packaged together.

When the subscriber line is not provisioned for POTS services, the local SLIC may provide POTS at the customer premises. The existing premises wiring may be utilized. The local SLIC can be connected to the customer premises POTS equipment through a telephone wall jack 394, for example.

In the absence of POTS provided by a SLIC 330 at the network access provider, the local SLIC 380 may provide POTS services. If POTS is provided by the SLIC at the network access provider, then the local SLIC should be prevented from providing POTS services to any equipment receiving POTS service throughout the customer premises via subscriber line 390. A relay 392 is provided to permit disabling injection in the event that the subscriber line is already provisioned for POTS services. The relay is effectively a transfer switch that allows for automated selection of POTS provider to the customer premises.

The customer may connect the local SLIC to a wall jack and rely upon the relay control to handle electrical coupling of the local SLIC to the customer premises equipment 370, 372. In the absence of POTS services provided by any network access provider SLIC, the relay may permit the local SLIC to provide POTS services to all POTS customer premises equipment via the existing premises wiring. When the network access provider SLIC is providing POTS services via subscriber line 390, the relay 392 should prohibit injection by the local SLIC 380. The local SLIC may still provide POTS services to any POTS equipment 373 that is isolated from the network access provider SLIC 330.

Local SLIC 380 includes a voice data interface and a processor interface coupled by lines 386 and 388, respectively, to the DSL modem. The processor interface 388 provides a mechanism for the DSL modem to act as a host controller for the local SLIC. In this manner, the DSL modem can configure the SLIC, place the SLIC in a particular state, cause the SLIC to perform various routines, etc.

The voice data interface 386 carries digitized voice data between a codec of the SLIC and the DSL modem. This configuration allows for the support of Voice Over Internet Protocol (VOIP) communications utilizing POTS equipment. Thus, for example, telephone 373 may be utilized for VOIP communications irrespective of whether local SLIC 380 is injecting POTS services via premises wiring to the remainder of the POTS equipment. If POTS is provided by the network access provider SLIC 330, then equipment 370, 372 will utilize the POTS band of the subscriber line for POTS communication between the network access provider and the customer premises. In the absence of POTS provided by the network access provider SLIC, equipment 370, 372 may be utilized for VOIP communications between the network access provider and the customer premises if local SLIC 380 is injecting the POTS services.

Through the appropriate sensing and configuration, the local SLIC 380 and DSL modem/router 350 may co-operate to support VOIP for dedicated VOIP POTS equipment such as telephone 373 while selecting between VOIP or POTS for the remaining customer premises equipment depending upon whether a network access provider SLIC 330 is already providing POTS services. In the absence of network access provider POTS, voiceband data from POTS equipment 370, 372 will be carried in digitized form in the xDSL portion of the communications spectrum of the subscriber line 390. In the presence of network access provider POTS, voiceband data from POTS equipment 370, 372 will be carried in analog form in the voiceband portion of the communication spectrum of the subscriber line. Voiceband communications from dedicated VOIP phone 373 is always carried in digital form in the xDSL portion of the communications spectrum of the subscriber line 390. Detection of the presence of POTS is necessary for control of relay 392 and injection by the local SLIC 380.

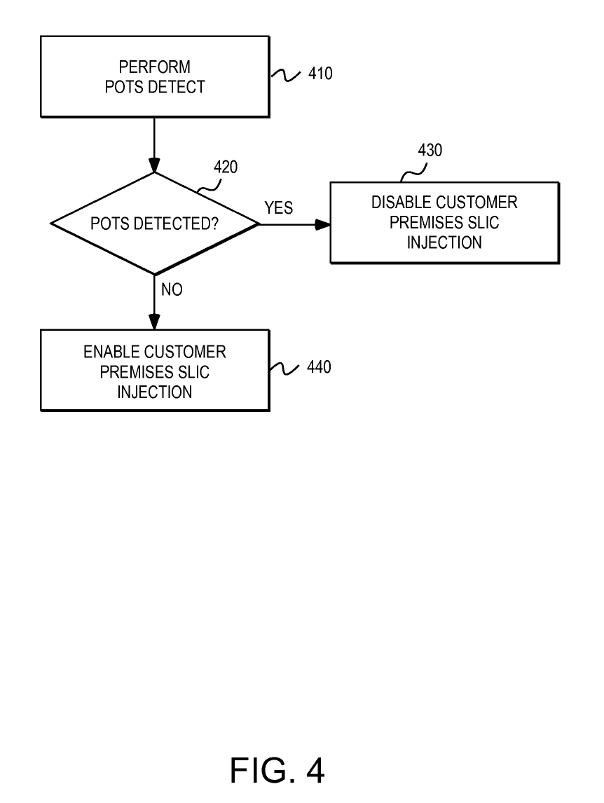

FIG. 4 illustrates one embodiment of a method of controlling a customer premises SLIC. In step 410, a POTS detect is performed. If POTS is detected as determined by step 420, then the customer premises SLIC POTS injection is disabled in step 430. Otherwise, the customer premises SLIC is POTS injection enabled in step 440. Such enabling may include controlling a relay to permit injection via an existing connection between the SLIC and the customer premises wiring.

In one embodiment, the customer premises SLIC is performing the detection. Thus if disabling entails disconnecting the SLIC from the subscriber line, the SLIC must be connected prior to performing the test. In one embodiment, the test is initiated only when an off-hook state is not detected (i.e., POTS equipment 370, 372 are in an on-hook state). In another embodiment, the test is performed at regular intervals until POTS is detected.

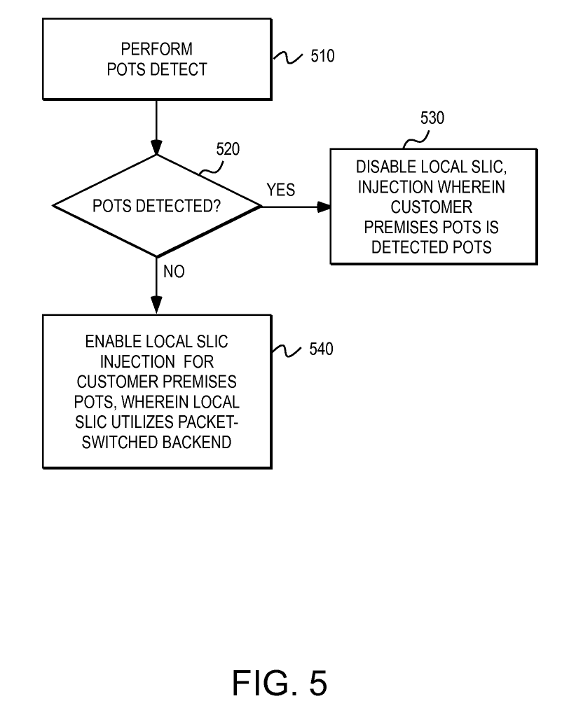

FIG. 5 illustrates another embodiment of a method of controlling a customer premises SLIC. In step 510, a POTS detect is performed. If POTS is detected as determined by step 520, then POTS injection by the customer premises or “local” SLIC is disabled in step 530. In such a case the detected POTS serves as the customer premises POTS. If POTS is not detected, then POTS injection by the local SLIC is enabled to provide the customer premises POTS in step 540.

The local SLIC backend may be coupled to a DSL modem for packet switched communications of the voice data on the subscriber line. In one embodiment, for example, the packets are carried by the same subscriber line that was the subject of the POTS detect. Thus in the event that POTS services are available, no re-injection is needed and POTS voiceband communications are carried along the subscriber line in the POTS band as indicated in FIG. 2. If POTS services are not available, the local SLIC is used to provide POTS to the customer premises equipment and voiceband communications are digitized and carried on the subscriber line using packet-based communication operating in the DSL portion of the spectrum.

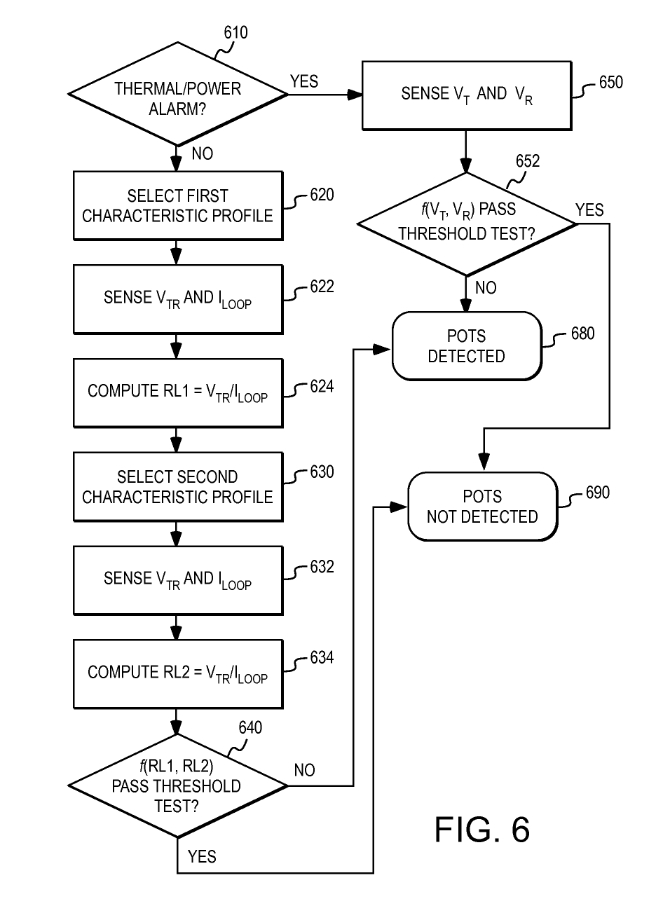

FIG. 6 illustrates one embodiment of a method of determining whether POTS is already provisioned to the customer premises via the subscriber line. Various approaches may be utilized to determine whether POTS is already provisioned as necessitated by steps 410 and 510 of FIGS. 4-5, respectively. The precise thresholds or values may depend in part upon the telephony standards in practice at the customer premises. In one embodiment the DSL modem commands the SLIC to initiate a POTS detect operation.

Step 610 determines whether a thermal alarm condition exists. Such an alarm may be the result of the local SLIC and a central office SLIC competing to drive the customer premises POTS lines and equipment. Modern SLICs have sensors and indicators to assess and indicate the presence of a thermal alarm condition.

If a thermal alarm condition exists as determined by step 610, then the local SLIC senses the tip voltage (V_{T}) and ring voltage (V_{R}) for the subscriber line in step 650. In one embodiment, the sensed values are determined by sensing an unprotected side of a protection device such as a fuse that couples the local SLIC to the subscriber line. Some SLICs include a “coarse” sense line for sensing the unprotected side of a protected line. In conjunction with sensing the protected side of the protected line, this allows the SLIC to determine whether a fuse (e.g., F1 of FIG. 3) is intact.

If a function of the tip voltage and ring voltage (i.e., ƒ(V_{T},V_{R})) exceeds a pre-determined threshold then POTS is presumed to be active. In various embodiments, one or both of the tip and ring voltages are compared with a threshold voltage. For example, if |V_{T}|>ρ_{T} or if |V_{R}|>ρ_{R}, then POTS is deemed present. In one embodiment, a difference between V_{T} and V_{R} is used to assess the presence of POTS. For example, if |V_{T}−V_{R}|>ρ_{TR} then POTS is deemed present.

The standard characteristic battery feed profiles used by a network access provider may vary based upon geographic territory. The threshold values (e.g., ρ_{T}, ρ_{R}, or ρ_{TR} should be selected in view of the battery feed characteristic profiles utilized for the locale of the customer premises.

If ƒ(V_{T},V_{R}) passes a threshold test as determined in step 652, then POTS is deemed to not be detected as indicated by 690. Otherwise, POTS is deemed present as indicated in 680.

If there is no thermal power alarm condition then the local SLIC selects a first characteristic profile for battery feed in step 620. Values for subscriber loop voltage (i.e., V_{TR}, the differential voltage between the tip and ring lines) and the subscriber loop current (I_{Loop}) are sensed in step 622. To differentiate sensed values for a particular characteristic profile, an index subscript may be utilized (e.g., V_{TR}_{₁}, I_{LOOP}_{₁}). From these values, a first loop resistance is computed in step 624 as

$$RL 1 = \frac{{V}_{{TR}_{1}}}{{I}_{{LOOP}_{1}}} .$$

A second characteristic profile for battery feed is selected in step 632. The subscriber loop voltage (V_{TR}_{₂}) and the subscriber loop current (I_{LOOP}_{₂}) are sensed in step 632. From these values, a second loop resistance is computed in step 634 as

$$RL 2 = \frac{{V}_{{TR}_{2}}}{{I}_{{LOOP}_{2}}} .$$

A predetermined function of RL1 and RL2 (ƒ(RL1, RL2)) is evaluated to determine whether a threshold test has been passed in step 640. If so, then POTS is deemed not present at 690, otherwise POTS is deemed present at 680. In one embodiment the function determines whether a ratio of RL1 and RL2 is within a pre-determined range. For example, in one embodiment if 0.7 RL1/RL2≦1.3, then POTS is deemed not present, otherwise POTS is deemed present.

In one embodiment, one of the first and second characteristic profiles is very similar to the POTS profile typically found in the locale while the other characteristic profile is significantly different. If POTS is present then one of the battery feed characteristic profiles will result in no substantial current flow while the other will result in a substantial current flow. The difference in current flow will aid in accurate detection of POTS.

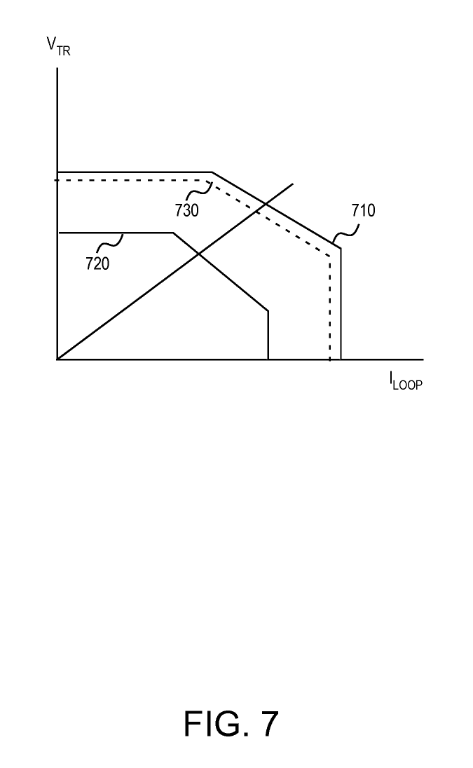

FIG. 7 illustrates one embodiment of a first characteristic profile 710 and a second characteristic profile 720 juxtaposed with the POTS battery feed profile 730 expected for the area. The first characteristic profile is substantially similar to POTS profile 730 while the second characteristic profile has significantly lower voltages. Thus in one embodiment, the first and second characteristic profiles are significantly different and at least one of them is substantially similar to the expected local POTS.

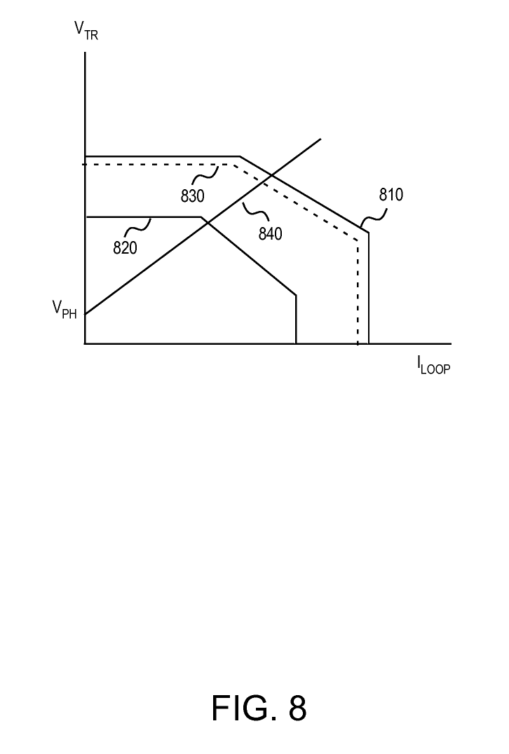

FIG. 8 illustrates one embodiment of a first characteristic profile 810 and a second characteristic profile 820 juxtaposed with the POTS battery feed profile 830 expected for the area. The first characteristic profile is substantially similar to POTS profile 830 while the second characteristic profile has significantly lower voltages. Thus in one embodiment, the first and second characteristic profiles are significantly different and at least one of them is substantially similar to the expected local POTS.

Regardless of the presence of POTS or the POTS equipment, the computation for R remains the same. The difference between a resistance only presence and a POTS equipment presence is a V_{TR} offset. Such an offset does not impact the computation of R.

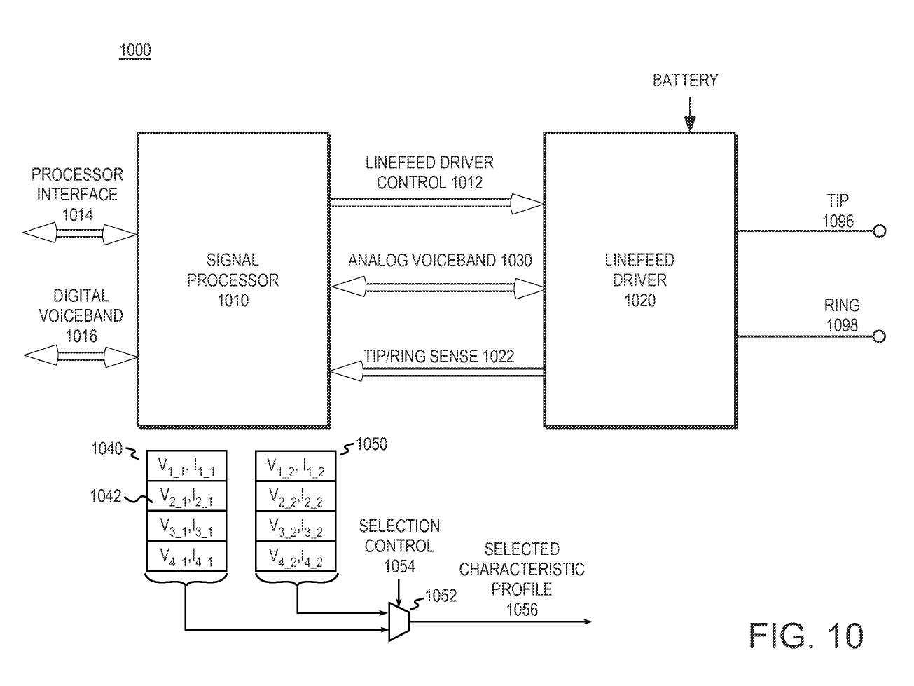

FIG. 10 illustrates one embodiment of an SLIC 1000 wherein the BORSCHT functions have been redistributed between a signal processor 1010 and a linefeed driver 1020. Signal processor 1010 is responsible for at least the ring control, supervision, codec, and hybrid functions. Signal processor 1010 controls and interprets the large signal subscriber loop control signals as well as handling the small signal analog voiceband data and the digital voiceband data.

In one embodiment, signal processor 1010 is an integrated circuit. The integrated circuit includes sense inputs for a sensed tip and ring signal of the subscriber loop. The integrated circuit generates subscriber loop linefeed driver control signal in response to the sensed signals. In one embodiment, the linefeed driver does not reside within the integrated circuit or within the same integrated circuit package as the signal processor 1010. In alternative embodiments, the signal processor may reside within the same integrated circuit package as at least a portion of the linefeed driver.

Signal processor 1010 receives subscriber loop state information from linefeed driver 1020 as indicated by tip/ring sense 1022. This information is used to generate control signals for linefeed driver 1020 as indicated by linefeed driver control 1012. The voiceband 1030 signal is used for bi-directional communication of the analog voiceband data between linefeed driver 1020 and signal processor 1010.

Signal processor 1010 includes a digital interface for communicating digitized voiceband data to the digital switching network using digital voiceband 1016. In one embodiment, the digital interface includes a processor interface 1014 to enable programmatic control of the signal processor 1010. The processor interface effectively enables programmatic or dynamic control of battery control, battery feed state control, voiceband data amplification and level shifting, longitudinal balance, ringing currents, and other subscriber loop control parameters as well as setting thresholds such as a ring trip detection thresholds and an off-hook detection threshold.

The digital voiceband data 1014 is coupled to a digital codec interface of signal processor 1010 for bi-directional communication of the digital voiceband data between the codec of the signal processor and the digital switching network. The analog voiceband data 1030 is coupled to an analog codec interface of signal processor 1010 for bi-directional communication of the analog voiceband data between the codec and the linefeed driver.

Linefeed driver 1020 maintains responsibility for battery feed to tip 1080 and ring 1090. Overvoltage protection is not explicitly illustrated, however, overvoltage protection can be provided by fuses incorporated into linefeed driver 1020, if desired. Linefeed driver 1020 includes sense circuitry to provide signal processor 1010 with pre-determined sensed subscriber loop operating parameters as indicated by tip/ring sense 1022. Signal processor 1010 performs any necessary processing on the sensed parameters in order to determine the operational state of the subscriber loop. For example, differences or sums of sensed voltages and currents are performed as necessary by signal processor 1010 rather than linefeed driver 1020. Thus common mode and differential mode components (e.g., voltage and current) of the subscriber loop are calculated by the signal processor rather than the linefeed driver.

Linefeed driver 1020 modifies the large signal tip and ring operating conditions in response to linefeed driver control 1012 provided by signal processor 1010. This arrangement enables the signal processor to perform processing as needed to handle the majority of the BORSCHT functions. For example, the supervisory functions of ring trip, ground key, and off-hook detection can be determined by signal processor 1010 based on operating parameters provided by tip/ring sense 1022.

Modern SLICs often provide the ability to program the battery feed characteristic profile. The profile may be loaded upon initialization of the SLIC or may otherwise reside in a programmable nonvolatile memory. The battery feed characteristic profile typically consists of four points expressed as current and voltage pairs (fewer points may be used in the event that the origin is deemed fixed). In order to utilize a different battery feed characteristic profile, one must reprogram the defining points of the programmable characteristic profile as appropriate. This might take, for example, at least 4 load and store operations that will occur sequentially rather than concurrently. Switching characteristic profiles through such a technique in order to perform a POTS detect operation could lead to undesired battery feed aberrations such as oscillations, etc. on the subscriber line.

In order to reduce the likelihood of such undesired events, in one embodiment the SLIC includes circuitry to facilitate selection of battery feed characteristic profiles as a whole. Instead of “re-defining” the profile by programming new values on a point-by-point basis, the entire characteristic profile is effectively switched at once.

In one embodiment, for example, a first memory 1040 and a second memory 1050 are included for storing characteristic profile values such as point 1042. Symbolized by multiplexer 1052, the selection of the characteristic profile is accomplished by the value of the control bit 1054 provided to the multiplexer 1052. The selected characteristic profile 1056 will be one of the first and second characteristic profiles (stored in first and second memories, respectively) that is selected in accordance with the selection control signal 1054. The selection control signal can be a single bit in the event there are only two characteristic profiles to choose from.

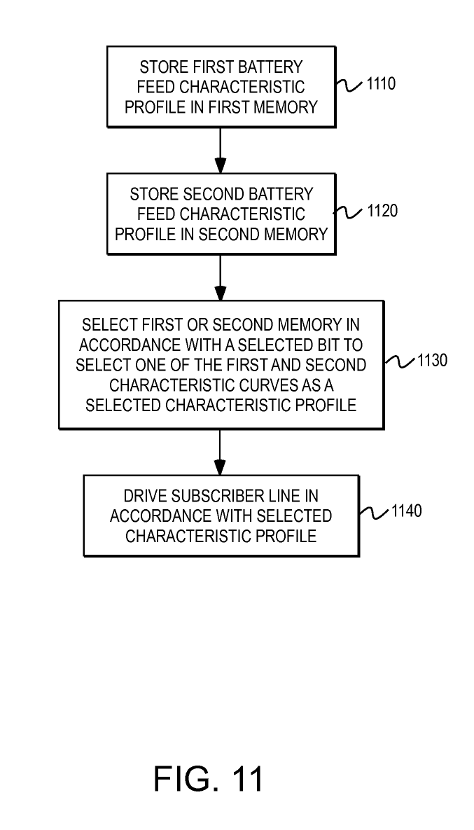

FIG. 11 illustrates one embodiment of a method of selecting a battery feed characteristic profile. A first battery feed characteristic profile is stored in a first memory in step 1110. A second battery feed characteristic profile is stored in a second memory in step 1120. The terms “first” and “second” memories do not require physically different packaging of the memory. The first and second memories may be separate storage areas of the same memory device, distinct memory devices of the same type, or even distinct memory devices of different types.

For example, in the event the memories are accessed through the use of addresses, then the first and second memories identify different address ranges. One memory may be a volatile memory storage device that must be loaded upon initialization of the SLIC while another memory may be a nonvolatile memory that preserves stored values even in the absence of power.

In step 1130, one of the first and second memories is selected to select one of the first and second characteristic profiles as a selected characteristic profile in accordance with the value of a selected bit. Thus instead of attempting multiple memory accesses to load a battery feed characteristic profile, one only needs to toggle a bit value. In case more than two profiles are to be used for testing for the presence of POTS or to accommodate selecting from among more than two preloaded characteristic profiles, multiple bits may be used to control the selection process. This might be the case, for example, if the SLIC is pre-loaded with a range of characteristic profiles to accommodate ease of implementing in a variety of locales utilizing different POTS standards.

In step 1140 the subscriber line is driven in accordance with the selected characteristic profile. By changing a single value, the entire characteristic profile utilized by the SLIC is switched. The alternative of individually modifying points specifying the characteristic profile during operation of the SLIC could otherwise lead to oscillations and other undesired outcomes.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A subscriber line interface circuit apparatus, comprising:
a first memory for storing a first battery feed characteristic profile;
a second memory for storing a second battery feed characteristic profile; and
selection circuitry for one of the first and second battery feed characteristic profiles from the corresponding first and second memories as a selected battery feed characteristic profile in accordance with a selection bit, wherein the subscriber line interface circuitry controls a subscriber line battery feed in accordance with the selected battery feed characteristic profile.

2. The apparatus of claim 1 wherein at least one of the first and second memories is programmable.

3. The apparatus of claim 1 wherein at least one of the first and second memories is a nonvolatile memory.

4. The apparatus of claim 1 wherein each of the first and second memories stores at least three points defining its associated battery feed characteristic profile.

5. A method of controlling a subscriber line interface circuit, comprising:
a) storing a first battery feed characteristic profile in a first memory of a subscriber line interface circuit;
b) storing a second battery feed characteristic profile in a second memory of the subscriber line interface circuit;
c) selecting one of the first and second memories to select one of the first and second battery feed characteristic profiles as a selected characteristic profile in accordance with the value of a selected bit; and
d) controlling the subscriber line battery feed in accordance with the selected characteristic profile.

6. The method of claim 5 wherein the first and second battery feed characteristic profiles are substantially different.

7. The method of claim 6 wherein one of the first and second battery feed characteristic profiles is substantially the same as a POTS characteristic profile specific to the locale of the location of the subscriber line interface circuit.
